(19) United States
(12) Patent Application Publication
(10) Pub. No.: US 2017/0106768 A1
(43) Pub. Date: Apr. 20, 2017

(54) Vehicle Occupancy Alert Device

(71) Applicant: Robert Curtis, Sweetser, IN (US)

(72) Inventor: Robert Curtis, Sweetser, IN (US)

(21) Appl. No.: 14/883,686

(22) Filed: Oct. 15, 2015

(51) Int. Cl. B60N 2/00; B60Q 9/00; G08B 21/24; B60Q 5/00

(52) U.S. Cl. CPC B60N 2/002; B60Q 5/005; B60Q 9/00; G08B 21/24

(57) ABSTRACT

A vehicle occupancy alert device for alerting a vehicle operator to back seat occupancy includes housing that is configured to couple to a vehicle. A processor is coupled to and positioned in the housing. The processor is operationally coupled to the vehicle's 12 volt power supply, door sensors and speaker. A plurality of sensors is configured to couple to the back seats of the vehicle. The sensors are operationally coupled to the processor and the vehicle's 12 volt power supply. The plurality of sensors are positioned such that occupancy of one or more of the back seats will signal the processor to monitor the vehicle's door sensors upon the vehicle being turned off. Should the driver's door open and close, the processer will send a warning to the vehicle's speaker to alert the vehicle operator and others nearby.

### BACKGROUND OF THE DISCLOSURE

Field of the Disclosure

The disclosure relates to occupancy alert devices and more particularly pertains to a new occupancy alert device for alerting a vehicle operator to back seat occupancy.

### SUMMARY OF THE DISCLOSURE

An embodiment of the disclosure meets the needs presented above by generally comprising a housing that is configured to couple to a vehicle. A processor is coupled to and positioned in the housing. The processor is operationally coupled to the vehicle's 12 volt power supply, door sensors and speaker. A plurality of sensors is configured to couple to the back seats of the vehicle. The sensors are operationally coupled to the processor and the vehicle's 12 volt power supply. The plurality of sensors are positioned such that occupancy of one or more of the back seats will signal the processor to monitor the vehicle's door sensors upon the vehicle being turned off. Should the driver's door open and close, the processer will send a warning to the vehicle's speaker to alert the vehicle operator and others nearby.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is an isometric perspective view of a vehicle occupancy alert device according to an embodiment of the disclosure.

FIG. 2 is an in-use view of an embodiment of the disclosure.

FIG. 3 is an in-use view of an embodiment of the disclosure.

FIG. 4 is a flow diagram of an embodiment of the disclosure.

### DESCRIPTION OF THE PREFERRED EMBODIMENT

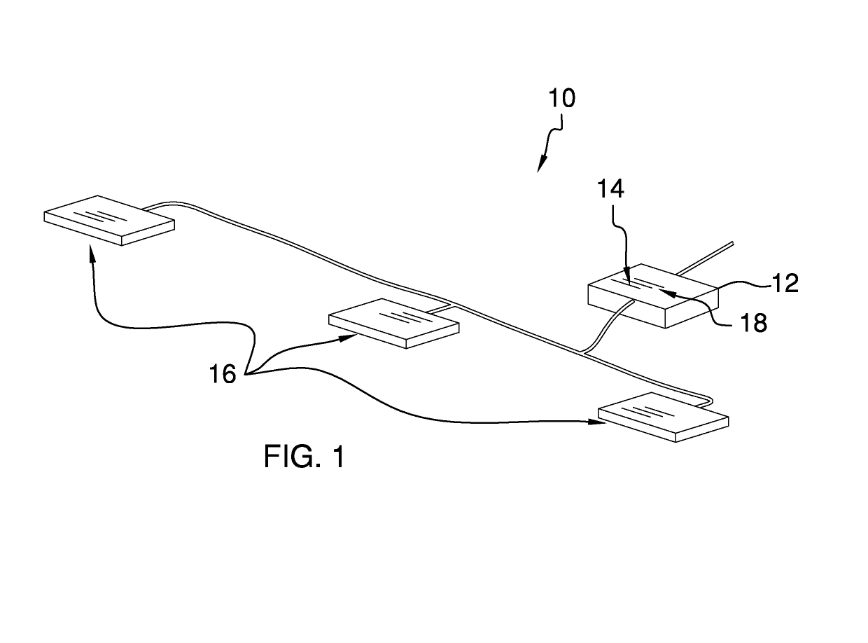

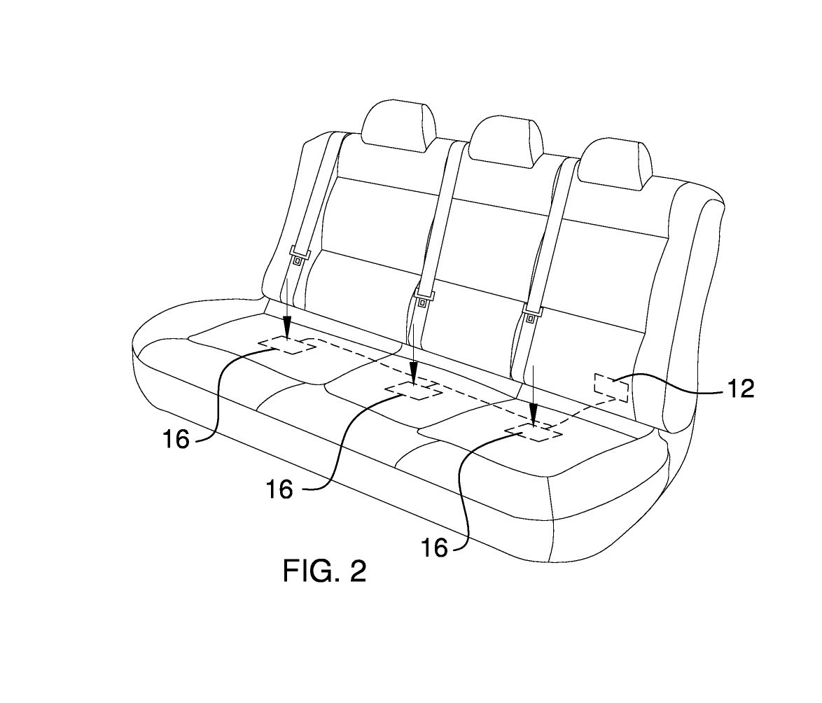

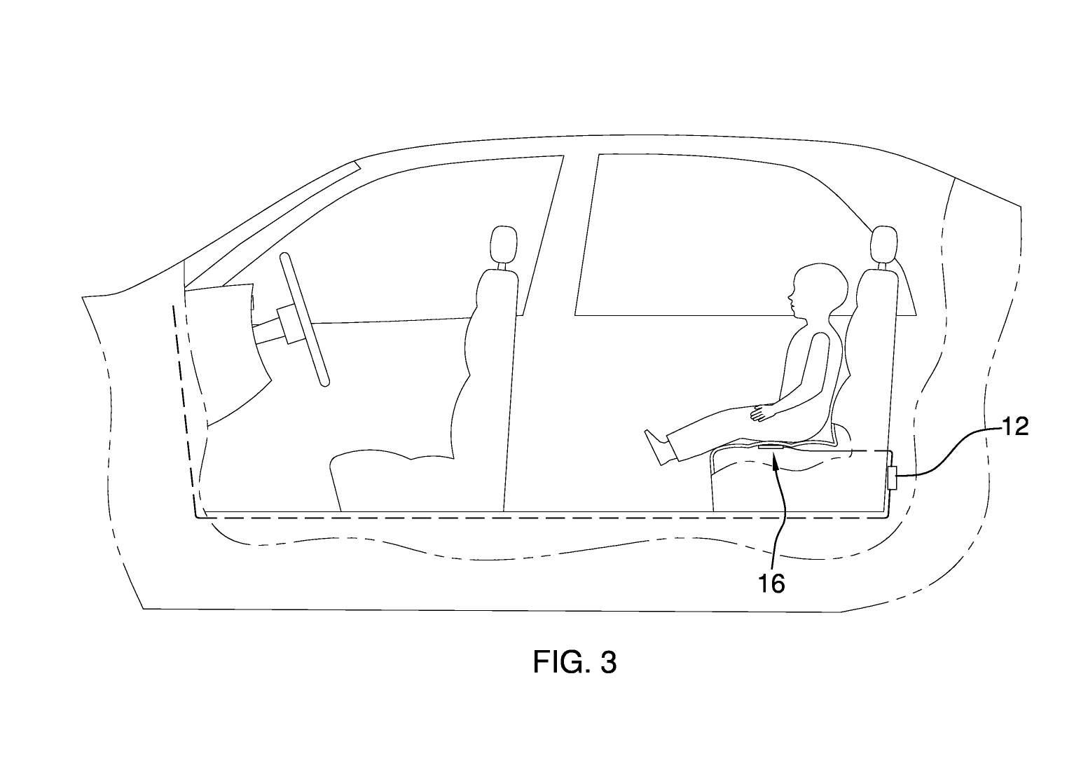

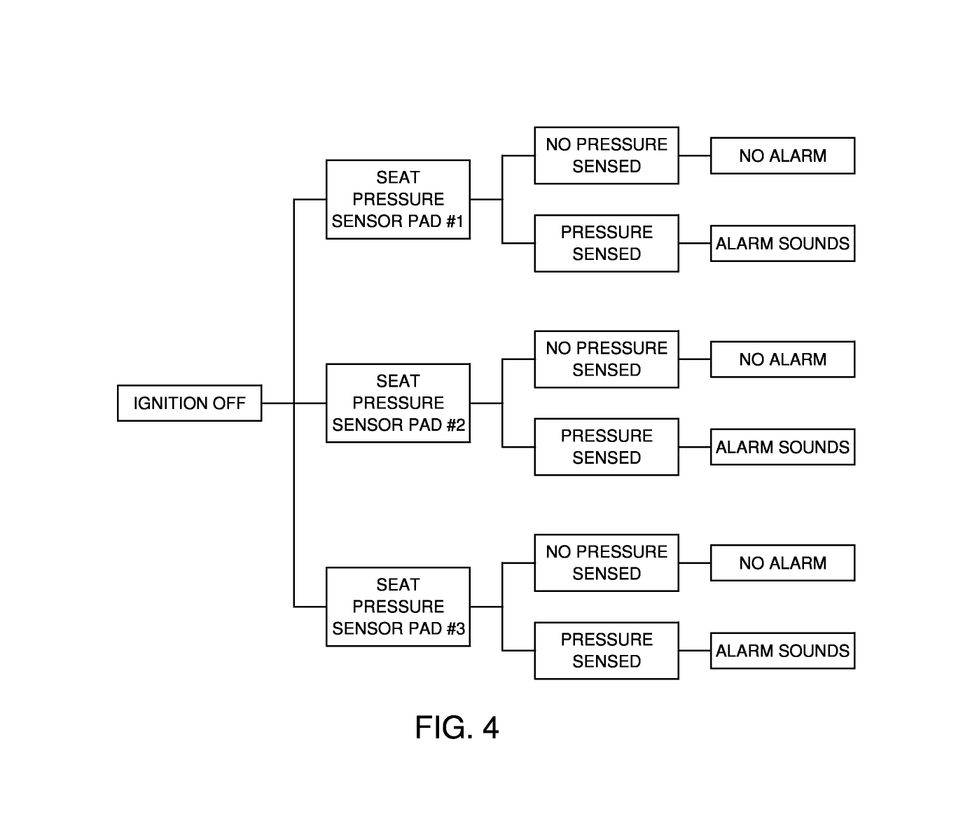

With reference now to the drawings, and in particular to FIGS. 1 through 4 thereof, a new occupancy alert device embodying the principles and concepts of an embodiment of the disclosure and generally designated by the reference numeral 10 will be described.

As best illustrated in FIGS. 1 through 4, the vehicle occupancy alert device 10 generally comprises a housing 12 that is configured to couple to a vehicle. A processor 14 is coupled to and positioned in the housing 12. The processor 14 is operationally coupled to the vehicle's 12 volt power supply, door sensors, speaker, horn and lights. The processor 14 may be the vehicle's onboard processor. A plurality of sensors 16 is configured to couple to the back seats of the vehicle. The sensors 16 are operationally coupled to the processor 14 and the vehicle's 12 volt power supply. The sensors 16 are weight detecting, and one of each of the plurality of sensors 16 is positioned in the back left, back right and back center seats of the vehicle to individually detect occupancy of the seats. The sensors 16 are configured to couple to the underside of the vehicle's back seat. A timer 18 is coupled to and positioned in the housing 12. The timer 18 is operationally coupled to the processor 14 and the vehicle's 12 volt power supply; such that a delay can be programmed into the processor 14 before an alert is issued. The timer 18 may be the vehicle's onboard timer.

In use, the plurality of sensors 16 are positioned such that occupancy of one or more of the back seats will signal the processor 14, upon the vehicle being turned off, to initiate the timer 18 and to monitor the vehicle's door sensors. Should the driver's door open and close, the processer 14 will send, upon confirmation of continued occupancy after a set period of time, a warning to the vehicle's speaker and a signal to the vehicle's horn and lights to engage, such that the vehicle operator and others nearby are alerted.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A vehicle occupancy alert system comprising:
a vehicle having a plurality of back seats;
a housing, said housing being coupled to said vehicle;
a processor, said processor being coupled to and positioned in said housing, said processor being operationally coupled to the vehicle's 12 volt power supply, door sensors and speaker;
a plurality of sensors, said sensors being coupled to the back seats of the vehicle, said sensors being operationally coupled to said processor and the vehicle's 12 volt power supply; and
wherein said plurality of sensors are positioned such that occupancy of one or more of the back seats will signal said processor to monitor the vehicle's door sensors upon the vehicle being turned off, and wherein the processer will send a warning to the vehicle's speaker, such that the vehicle operator and others nearby are alerted.

2. The system of claim 1, further including a timer, said timer being coupled to and positioned in said housing, said timer being operationally coupled to said processor and the vehicle's 12 volt power supply.

3. The system of claim 2, further including said timer being the vehicle's onboard timer.

4. The system of claim 1, further including said processor being operationally coupled to the vehicle's horn, wherein said processor is enabled to engage a horn of the vehicle to warn of back seat occupancy.

5. The system of claim 1, further including said processor being operationally coupled to the vehicle's lights, wherein said processor is enabled to engage the lights to warn of back seat occupancy.

6. The system of claim 1, further including said processor being the vehicle's onboard processor.

7. The system of claim 1, further including said sensors being weight detecting.

8. The system of claim 1, further including one of each said plurality of sensors being positioned in the back left, back right and back center seats of the vehicle.

9. The device of claim 1, further including.

10. A vehicle occupancy alert system comprising:
a vehicle having a plurality of back seats;
a housing, said housing being coupled to said vehicle;
a processor, said processor being coupled to and positioned in said housing, said processor being operationally coupled to the vehicle's 12 volt power supply, door sensors, speaker, horn and lights, said processor being the vehicle's onboard processor;
a plurality of sensors, said sensors being coupled to the back seats of the vehicle, said sensors being operationally coupled to said processor and the vehicle's 12 volt power supply, said sensors being weight detecting, one of each said plurality of sensors being positioned in the back left, back right and back center seats of the vehicle, said sensors being configured to couple to the underside of the vehicle's back seat;
a timer, said timer being coupled to and positioned in said housing, said timer being operationally coupled to said processor and the vehicle's 12 volt power supply, said timer being the vehicle's onboard timer; and
wherein said plurality of sensors are positioned such that occupancy of one or more of the back seats will signal said processor, upon the vehicle being turned off, to initiate said timer and to monitor the vehicle's door sensors and wherein the processer will send, upon confirmation of continued occupancy after a set period of time, a warning to the vehicle's speaker and a signal to the vehicle's horn and lights to engage, such that the vehicle operator and others nearby are alerted.
